(19) United States
(12) Patent Application Publication
(10) Pub. No.: US 2019/0103096 A1
(43) Pub. Date: Apr. 4, 2019

(54) OUTPUT CONTROL DEVICE, OUTPUT CONTROL METHOD, AND PROGRAM

(71) Applicant: NEC CORPORATION, Tokyo (JP)

(72) Inventors: Jun KOBAYASHI, Tokyo (JP); Shigetsu SAITO, Tokyo (JP)

(73) Assignee: NEC CORPORATION, Tokyo (JP)

(21) Appl. No.: 16/085,664

(22) PCT Filed: Feb. 21, 2017
(86) PCT No.: PCT/JP2017/006351

§ 371 Date: Sep. 17, 2018

(30) Foreign Application Priority Data
Mar. 23, 2016 (JP) 2016-058346

(51) Int. Cl. G10L 15/18; G10L 17/00; G06F 16/583

(52) U.S. Cl. CPC G10L 15/18; G06F 16/583; G10L 17/005

(57) ABSTRACT

An output control device includes a control unit configured to cause an output device to output first information including a plurality of types of information, and an information determination unit configured to identify a type to be presented to a person and determine second information of the identified type on the basis of the first information output by the output device and a response of the person to the first information, wherein the control unit is configured to cause the output device or another output device to output the second information determined by the information determination unit.

### TECHNICAL FIELD

The present invention relates to an output control device, an output control method, and a program.

### BACKGROUND ART

Digital signage devices capable of electrically changing display details in a signage device installed in a space such as the inside of a facility are known. In the digital signage devices, technology for changing display details according to a viewer is known (see, for example, Patent Document 1). Also, besides the digital signage devices, output devices configured to output information to a person located at a predetermined location such as a parametric speaker are known.

### CITATION LIST

### Patent Literature

[Patent Document 1]

Japanese Unexamined Patent Application, First Publication No. 2012-252613

### SUMMARY OF INVENTION

### Technical Problem

Available languages of persons receiving information provided by an output device are not necessarily the same. Also, subjects of interest of persons receiving information provided by the output device are not necessarily the same. Thus, if the output device outputs information about a language different from an available language of a target person or information about a subject in which the target person is not interested, there is a possibility that appropriate information cannot be delivered to the person.

An objective of the present invention is to provide an output control device, an output control method, and a program for solving the above-described problems.

### Solution to Problem

According to a first aspect of the present invention, there is provided an output control device, including: a control unit configured to cause an output device to output first information including a plurality of types of information; and an information determination unit configured to identify a type to be presented to a person and determine second information of the identified type on the basis of the first information output by the output device and a response of the person to the first information, wherein the control unit is configured to cause the output device or another output device to output the second information determined by the information determination unit.

According to a second aspect of the present invention, there is provided an output control method, including: causing an output device to output first information including a plurality of types of information; identifying a type to be presented to a person and determining second information of the identified type on the basis of the first information output by the output device and a response of the person to the first information; and causing the output device or another output device to output the determined second information.

According to a third aspect of the present invention, there is provided a program for causing a computer to execute the processes of: causing an output device to output first information including a plurality of types of information; identifying a type to be presented to a person and determining second information of the identified type on the basis of the first information output by the output device and a response of the person to the first information; and causing the output device or another output device to output the determined second information.

### Advantageous Effects of Invention

According to the present invention, it is possible to cause an output device to output information according to a person of a presentation target.

### BRIEF DESCRIPTION OF DRAWINGS

FIG. 1 is a schematic diagram showing a configuration of an information output system according to a first embodiment.

FIG. 2 is a schematic block diagram showing a configuration of an output control device according to the first embodiment.

FIG. 3 is an example of a candidate image according to the first embodiment.

FIG. 4 is a flowchart showing an operation of the output control device according to the first embodiment.

FIG. 5 is a schematic diagram showing a configuration of an information output system according to a second embodiment.

FIG. 6 is a schematic block diagram showing a configuration of an output control device according to the second embodiment.

FIG. 7 is a flowchart showing an available language estimation process of the output control device according to the second embodiment.

FIG. 8 is a flowchart showing an advertisement information display process of the output control device according to the second embodiment.

FIG. 9 is a schematic block diagram showing a basic configuration of the output control device.

FIG. 10 is a schematic block diagram showing a configuration of a computer according to at least one embodiment.

### DESCRIPTION OF EMBODIMENTS

### First Embodiment

### <<Configuration>>

Hereinafter, embodiments will be described in detail with reference to the drawings.

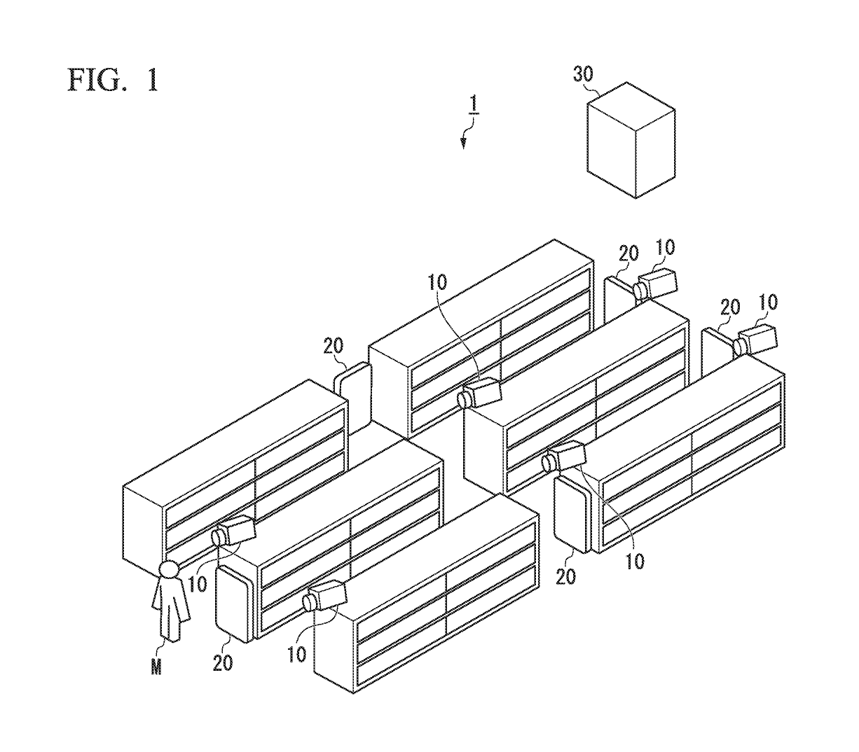

FIG. 1 is a schematic diagram showing a configuration of an information output system according to a first embodiment.

An information output system 1 according to the first embodiment is provided within a shop. The information output system 1 causes advertisement information according to a person M to be displayed to the person M within the shop.

The information output system 1 includes a plurality of imaging devices 10, a plurality of digital signage devices 20, and an output control device 30.

Each of the plurality of imaging devices 10 is provided within the shop. The imaging device 10 is installed so that at least a passage in front of each digital signage device 20 is included in an imaging range of any one of the imaging devices 10. An image captured by each imaging device 10 is transmitted to the output control device 30.

The plurality of digital signage devices 20 display images in accordance with instructions of the output control device 30. The digital signage device 20 is an example of an output device.

The output control device 30 controls the display of each digital signage device 20 on the basis of the image captured by the imaging device 10.

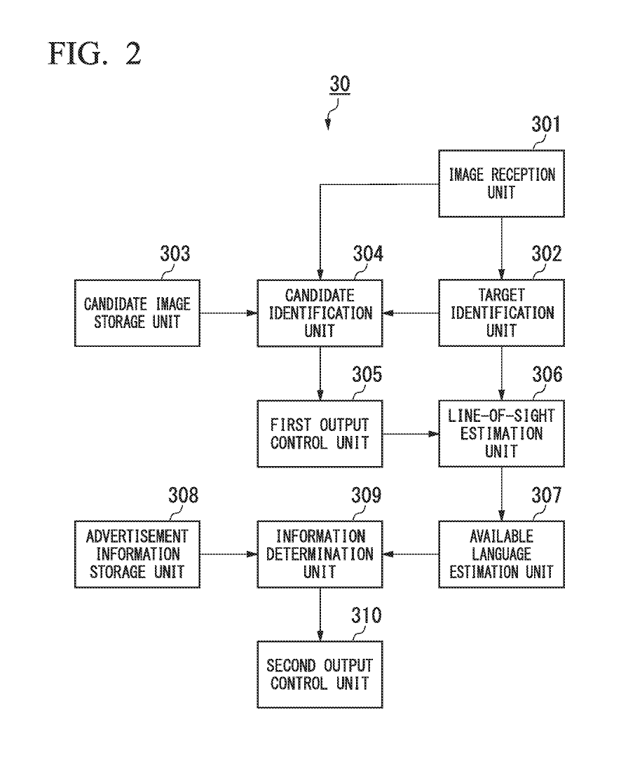

FIG. 2 is a schematic block diagram showing a configuration of an output control device according to the first embodiment.

The output control device 30 includes an image reception unit 301, a target identification unit 302, a candidate image storage unit 303, a candidate identification unit 304, a first output control unit 305, a line-of-sight estimation unit 306, an available language estimation unit 307, an advertisement information storage unit 308, an information determination unit 309, and a second output control unit 310.

The image reception unit 301 acquires an image from the imaging device 10.

On the basis of the image received by the image reception unit 301, the target identification unit 302 identifies a person M located within a predetermined distance in front of the digital signage device 20 as a person of an information output target. For example, the target identification unit 302 identifies a front area in the vicinity of the digital signage device 20, i.e., an area in which the range in which display details of the digital signage device 20 can be visually recognized, in the image received by the image reception unit 301 and determine whether or not the person M is shown within the area. Also, for example, the target identification unit 302 performs flow line analysis of the person M on the basis of the image captured by the imaging device 10, and compares position information of the person M obtained in the flow line analysis with an installation position of the digital signage device 20 to determine whether or not the person M is located in a front area in the vicinity of the digital signage device 20.

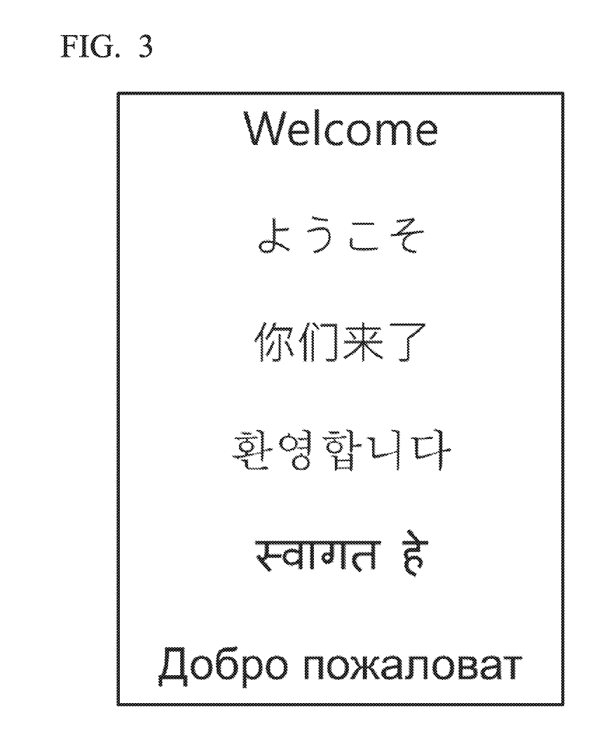

The candidate image storage unit 303 stores each race and each of candidate images including images of a plurality of available language candidates for a person related to each race in association. FIG. 3 is an example of a candidate image according to the first embodiment. For example, the candidate image storage unit 303 stores a candidate image including images of each of character strings written in English, Chinese, Japanese, Korean, Hindi, and Russian as shown in FIG. 3 in association with the yellow races. All the character strings of the languages included in the candidate image indicate the same details (for example, “Welcome,” “Hello,” and the like). The candidate image storage unit 303 stores a range in which there is a character string related to each language in the candidate image for each candidate image.

The candidate identification unit 304 estimates the race of the person M identified by the target identification unit 302 and determines a candidate image to be presented to the person M among a plurality of candidate images stored by the candidate image storage unit 303. For example, the candidate identification unit 304 provides facial feature amount information for each race in advance and identifies a race related to the facial feature amount information with a highest degree of similarity as the race of the person M. That is, the candidate identification unit 304 identifies a plurality of available language candidates on the basis of the face information of the person M.

The first output control unit 305 causes the digital signage device 20 in the vicinity of the person identified by the target identification unit 302 to display the candidate image determined by the candidate identification unit 304. That is, the first output control unit 305 causes the digital signage device 20 to output character strings expressed in a plurality of languages.

The line-of-sight estimation unit 306 estimates a line of sight of the person M identified by the target identification unit 302. For example, the line-of-sight estimation unit 306 can estimate the line of sight by identifying positions of pupils of both eyes of the person M on the basis of the image captured by a camera provided in the digital signage device 20 located in the vicinity of the imaging device 10 or the person M. Also, for example, the line-of-sight estimation unit 306 can estimate the line of sight by capturing reflected light of light provided in the digital signage device 20 located in the vicinity of the person M by the camera provided in the digital signage device 20 and identifying an amount of corneal reflection from the person M.

The available language estimation unit 307 estimates an intersection between the line of sight estimated by the line-of-sight estimation unit 306 and the digital signage device 20 and estimates a language displayed at the intersection as the available language of the person M. That is, the available language estimation unit 307 estimates the available language of the person M on the basis of a candidate image output by the digital signage device 20 and a response of the person M to the candidate image. The response of the person M to the candidate image indicates action taken by the person M, and is, for example, visual recognition of the digital signage device 20 by the person M.

The advertisement information storage unit 308 stores the language and advertisement information including a character string of the language in association.

The information determination unit 309 determines the advertisement information associated with the available language estimated by the available language estimation unit 307 as information to be presented to the person M among the advertisement information stored by the advertisement information storage unit 308.

The second output control unit 310 causes the digital signage device 20 located in the vicinity of the person M to display the information determined by the information determination unit 309.

### <<Operation>>

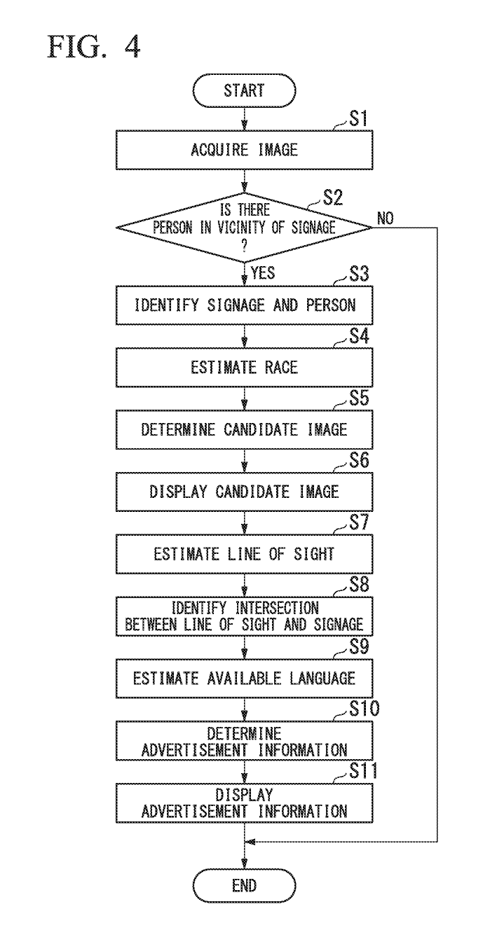

FIG. 4 is a flowchart showing the operation of the output control device according to the first embodiment.

When the output control device 30 is activated, the image reception unit 301 receives (acquires) an image from each imaging device 10 (step S1). When the image reception unit 301 receives the image, the target identification unit 302 determines whether or not the person M is located in a front area in the vicinity of the digital signage device 20 (step S2). If the person M is not located in a front area in the vicinity of the digital signage device 20 (step S2: NO), the output control device 30 terminates the process and waits for the next image to be received.

On the other hand, if the person M is located in a front area in the vicinity of the digital signage device 20 (step S2: YES), the target identification unit 302 identifies the person M located in a front area in the vicinity of the digital signage device 20 and the digital signage device 20 (step S3). For example, identifying the person M includes identifying an image in which the person M is shown among a plurality of images received by the image reception unit 301 and identifying an area in which the person M is shown in the image received by the image reception unit 301. Identifying the digital signage device 20 includes identifying an ID (identification) of the digital signage device 20.

Next, the candidate identification unit 304 estimates a race of the person M identified by the target identification unit 302 (step S4). Next, the candidate identification unit 304 determines a candidate image associated with the identified race as a candidate image to be presented to the person M, and reads the candidate image from the candidate image storage unit 303 (step S5). Next, the first output control unit 305 transmits an instruction for outputting the candidate image read by the candidate identification unit 304 to the digital signage device 20 identified in step S3 (step S6). Thereby, the digital signage device 20 located in the vicinity of the person M displays a candidate image including available language candidates for the person M.

Next, the line-of-sight estimation unit 306 estimates a line of sight of the person M identified in step S3 (step S7). Next, the available language estimation unit 307 identifies an intersection between the line of sight estimated by the line-of-sight estimation unit 306 and the digital signage device 20 (step S8). For example, if the line-of-sight estimation unit 306 identifies the line of sight in a three-dimensional orthogonal coordinate system, the available language estimation unit 307 calculates an intersection between a straight line representing the identified line of sight and a plane representing a display surface of the digital signage device 20 in the same rectangular coordinate system. Next, the available language estimation unit 307 estimates a language of the character string to be displayed at the identified intersection among character strings included in the candidate image determined in step S5 as the available language of the person M (step S9). Because the candidate image storage unit 303 stores a range in which there is a character string related to each language in the candidate image for each candidate image, the available language estimation unit 307 can estimate the available language by acquiring a language associated with a range including the identified intersection in the determined candidate image from the candidate image storage unit 303.

If character strings of a plurality of languages are simultaneously displayed, the person M visually recognizes a character string expressed in a familiar available language, normally. This is because it is possible to easily read details of the character string expressed in the available language compared with the character strings expressed in other languages. Therefore, the available language estimation unit 307 can estimate the language of the character string displayed at a part that intersects the line of sight of the person M in the candidate image as the available language of the person M.

The information determination unit 309 determines the advertisement information to be presented to the person M by reading the advertisement information associated with the estimated available language from the advertisement information storage unit 308 (step S10). The second output control unit 310 transmits an instruction for outputting the advertisement information read by the information determination unit 309 to the digital signage device 20 identified in step S3 (step S11). Thereby, the digital signage device 20 located in the vicinity of the person M displays advertisement information expressed in the available language of the person M.

### <<Operation and Effects>>

As described above, according to the first embodiment, the output control device 30 causes the digital signage device 20 to output character strings expressed in a plurality of languages, and determines advertisement information to be presented to the person M on the basis of the character strings and visual recognition action of the digital signage device 20 by the person M. Thereby, the output control device 30 can present advertisement information expressed in the available language of the person M to the person M. Thereby, the output control device 30 can cause the digital signage device 20 to output information according to the person M.

Also, according to the first embodiment, the character strings displayed in the candidate image are character strings of the same details expressed in different languages. Thereby, because the person M is interested in details of the displayed character string, it is possible to prevent gazing at a character string expressed in a language other than the available language.

Also, according to the first embodiment, the output control device 30 identifies a plurality of available language candidates on the basis of face information of the person M. Thereby, it is possible to appropriately reduce the number of character strings to be displayed in the candidate image.

### MODIFIED EXAMPLES

Also, although the character strings displayed in the candidate image are character strings of the same details expressed in different languages according to the first embodiment, the present invention is not limited thereto. For example, in other embodiments, character strings of different details and different languages may be included in the candidate image.

Also, although the candidate identification unit 304 identifies a plurality of available language candidates on the basis of the face information of a person according to the first embodiment, the present invention is not limited thereto. For example, in another embodiment, the output control device 30 may cause the digital signage device 20 to display a candidate image including all languages capable of being displayed without the candidate identification unit 304 being included.

Also, although the output control device 30 includes the first output control unit 305 and the second output control unit 310 according to the first embodiment, the present invention is not limited thereto. For example, in another embodiment, the first output control unit 305 and the second output control unit 310 may be configured as the same control unit.

### Second Embodiment

A second embodiment will be described.

In the first embodiment, an available language of a person M is estimated on the basis of a line of sight of the person M toward a candidate image displayed on the digital signage device 20. On the other hand, in the second embodiment, the available language of the person M is estimated on the basis of a response of the person M to speech guidance.

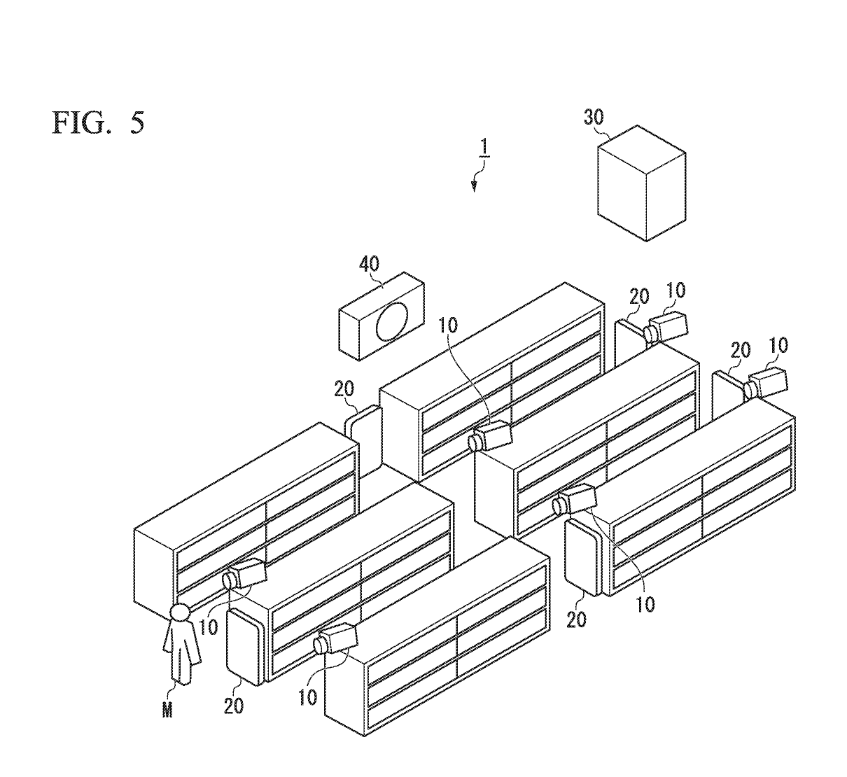

FIG. 5 is a schematic diagram showing a configuration of an information output system according to the second embodiment.

An information output system 1 according to the second embodiment further includes a speaker 40 in addition to the configuration of the first embodiment. The speaker 40 emits speech information within a facility. It is assumed that a speech emitted from the speaker 40 can be heard at least at an installation position of each digital signage device 20. The speaker 40 is an example of an output device.

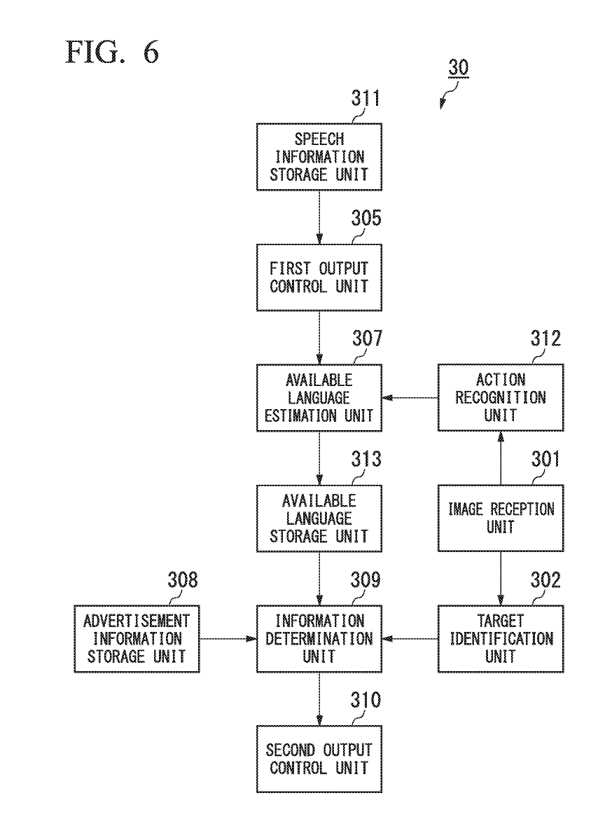

FIG. 6 is a schematic block diagram showing a configuration of the output control device according to the second embodiment.

An output control device 30 according to the second embodiment includes a speech information storage unit 311 and an action recognition unit 312 in place of the candidate image storage unit 303, the candidate identification unit 304, and the line-of-sight estimation unit 306 in the configuration of the first embodiment. Also, the operations of a first output control unit 305 and an available language estimation unit 307 are different from those of the first embodiment.

The speech information storage unit 311 stores speech information including a plurality of announcements spoken in different languages. Details of the announcements are all the same. The speech information storage unit 311 stores the language related to the announcement and a reproduction position of speech information at which the announcement is started in association.

The action recognition unit 312 recognizes a response of the person M (i.e., a change in action taken by the person M). An example of the change in action taken by the person M includes a change in a walking state and a change in a line of sight. More specifically, as an example of the change in action, it is assumed that the person M stops walking, a walking speed of the person M decreases, the line of sight of the person M changes from a front area in the traveling direction to another direction (for example, a direction in which the speaker 40 is installed).

The available language storage unit 313 stores feature information of the person M and an available language estimated by the language estimation unit 307 in association. Examples of the feature information include facial features, clothing, and a walking pattern.

The first output control unit 305 transmits an output instruction for causing speech information stored by the speech information storage unit 311 to be output to the speaker 40.

The available language estimation unit 307 estimates the available language of the person M on the basis of an output timing of the speech information from the speaker 40 and a timing of a change in the action of the person M. Specifically, if the action of the person M changes when a speech of a certain language is being output from the speaker 40, the available language estimation unit 307 estimates the language as the available language of the person M. The available language estimation unit 307 stores the feature information of the person M and the estimated available language in association in the available language storage unit 313.

### <<Operation>>

The output control device 30 according to the second embodiment executes an available language estimation process of recording an available language of the person M in the available language storage unit 313 and an advertisement information display process of causing the digital signage device 20 to display advertisement information by using information stored by the available language storage unit 313.

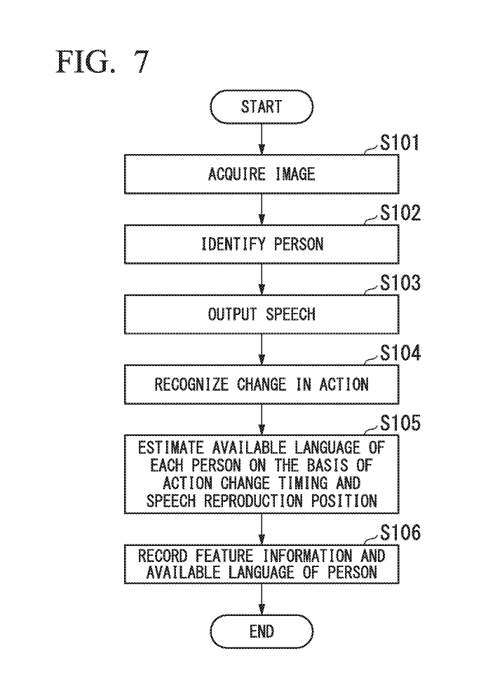

FIG. 7 is a flowchart showing an available language estimation process of the output control device according to the second embodiment.

The output control device 30 executes the available language estimation process at a timing at which speech information is to be output from the speaker 40 (for example, every five minutes). When the output control device 30 starts the available language estimation process, the image reception unit 301 receives (acquires) an image from the imaging device 10 (step S101).

Next, the action recognition unit 312 identifies a person who is an action recognition target from the received image (step S102). Next, the first output control unit 305 reads speech information from the speech information storage unit 311 and transmits a speech information output instruction to the speaker 40 (step S103). Thereby, the speaker 40 outputs speech information including announcements in a plurality of languages.

Next, the action recognition unit 312 recognizes a change in action of each person M identified in step S102 (step S104). At this time, the action recognition unit 312 identifies a time at which action changed for each person M. Next, the available language estimation unit 307 estimates an available language of the person M on the basis of an output timing of the speech information from the speaker 40 and a timing of a change in action of the person M (step S105). Specifically, the available language estimation unit 307 identifies a period from a time at which the speech information output instruction was transmitted in step S103 to a time at which a change in action was identified in step S104 as a reproduction position related to a timing at which action of the person M changed in the speech information. Then, the available language estimation unit 307 estimates the available language of the person M by identifying a language of an announcement output at the reproduction position identified from the speech information storage unit 311. The available language estimation unit 307 records the feature information of each person M identified in step S102 and the available language of the person M in association in the available language storage unit 313 (step S106).

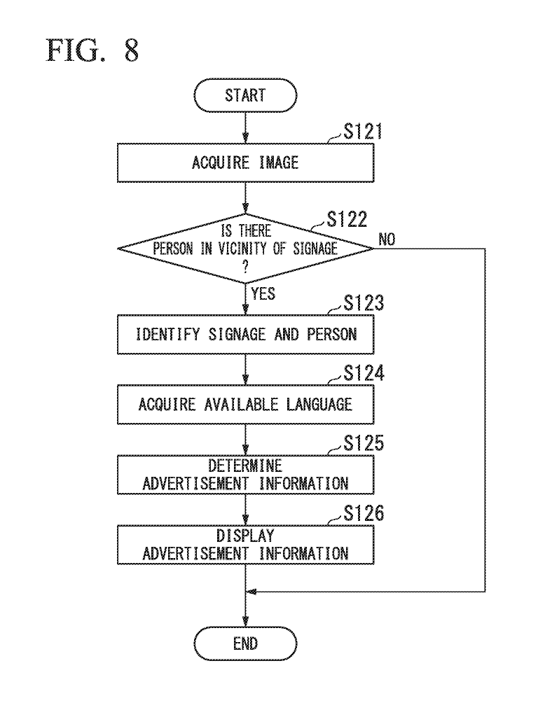

FIG. 8 is a flowchart showing an advertisement information output process of the output control device according to the second embodiment.

The output control device 30 executes the advertisement information output process at predetermined time intervals (for example, every 5 seconds). When the output control device 30 starts the advertisement information display process, the image reception unit 301 receives (acquires) an image from each imaging device 10 (step S121). When the image reception unit 301 receives an image, the target identification unit 302 determines whether or not the person M is located in a front area in the vicinity of the digital signage device 20 (step S122). When the person M is not located in a front area in the vicinity of the digital signage device 20 (step S122: NO), the output control device 30 terminates the process and waits for the next image to be received.

On the other hand, if the person M is located in a front area in the vicinity of the digital signage device 20 (step S122: YES), the target identification unit 302 identifies the person M located in a front area in the vicinity of the digital signage device 20 and the digital signage device 20 (step S123).

Next, the information determination unit 309 refers to the available language storage unit 313 on the basis of the feature information of the person M identified in step S123, and acquires a language associated with the feature information (step S124).

Next, the information determination unit 309 determines the advertisement information to be presented to the person M by acquiring the advertisement information associated with the language from the advertisement information storage unit 308 (step S125). The second output control unit 310 transmits an instruction for outputting the advertisement information acquired by the information determination unit 309 to the digital signage device 20 identified in step S123 (step S126). Thereby, the digital signage device 20 located in the vicinity of the person M displays advertisement information expressed in the available language of the person M.

### <<Operation and Effects>>

As described above, according to the second embodiment, the output control device 30 causes the speaker 40 to output an announcement in a plurality of languages and determines advertisement information to be presented to the person M on the basis of the announcement and a response of the person M to the announcement. Thereby, the output control device 30 can present advertisement information expressed in the available language of the person M to the person M. Thereby, the output control device 30 can cause the digital signage device 20 to output information according to the person M.

Also, according to the second embodiment, the announcement included in the speech information is an announcement of the same details expressed in different languages. Thereby, because the person M is interested in details of the output announcement, it is possible to prevent action from changing at an output timing of an announcement expressed in a language other than the available language.

### MODIFIED EXAMPLES

Also, although an announcement included in speech information is an announcement of the same details expressed in different languages according to the second embodiment, the present invention is not limited thereto. For example, in another embodiment, announcements of different details and different languages may be included in the speech information.

Also, in another embodiment, as in the first embodiment, the output control device 30 includes the candidate identification unit 304, and the candidate identification unit 304 may identify a plurality of available language candidates on the basis of face information of a person. In this case, the first output control unit 305 causes speech information including an announcement of the identified language candidate to be output from the speaker 40.

### Other Embodiments

Although embodiments have been described above in detail with reference to the drawings, specific configurations are not limited to those described above, and various design changes and the like can be made.

For example, although the information output system 1 according to the above-described embodiment may present information by estimating an available language of the person M, the present invention is not limited thereto. For example, the information output system 1 according to another embodiment may present information by estimating preferences of the person M. Specifically, the candidate image storage unit 303 may store an image including different information other than a language such as an image including a plurality of different products as a candidate image. In this case, it is estimated that an image related to an intersection between the line of sight of the person M and the digital signage device 20 reflects the preferences of the person M. Therefore, the second output control device 30 can present information according to the preferences of the person M.

Also, although the output of the digital signage device 20 is controlled by the output control device 30 provided separately from the digital signage device 20 in the information output system 1 according to the above-described embodiment, the present invention is not limited thereto. For example, in the information output system 1 according to another embodiment, each digital signage device 20 may have the function of the output control device 30.

Also, although the information output system 1 includes the digital signage device 20 serving as an output device in the above-described embodiment, the present invention is not limited thereto. For example, the information output system 1 according to another embodiment may include other output devices configured to output information to a person located at a predetermined location, such as a parametric speaker.

Also, although the output control device 30 stores advertisement information in the above-described embodiment, the present invention is not limited thereto and the advertisement information may be stored in a database or the like outside the output control device 30.

### <<Basic Configuration>>

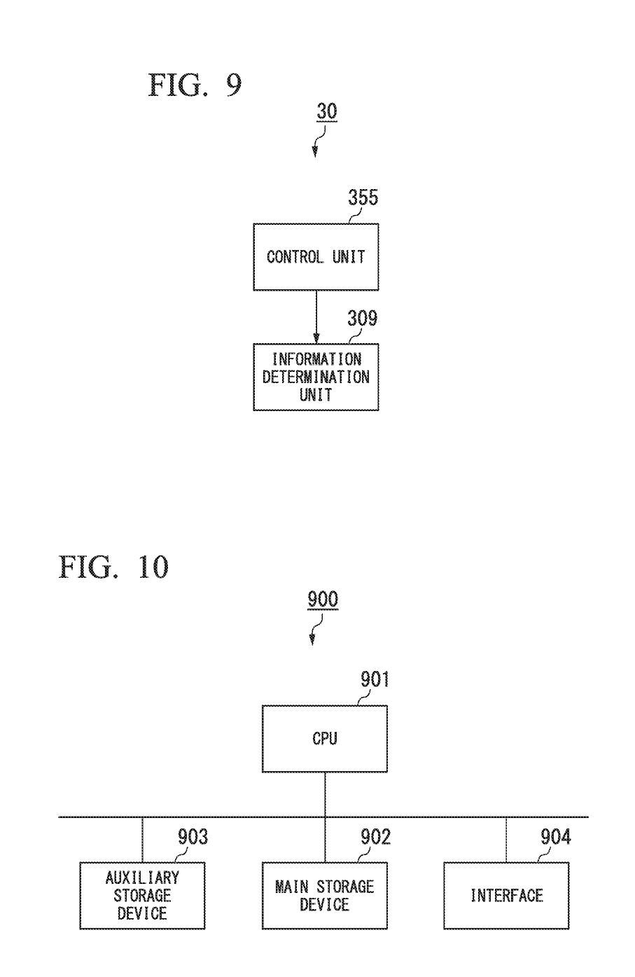

FIG. 9 is a schematic block diagram showing a basic configuration of the output control device.

Although the configuration shown in FIGS. 2 and 6 has been described as an embodiment of the output control device 30 in the above-described embodiment, the basic configuration of the output control device 30 is as shown in FIG. 9.

That is, the output control device 30 has a control unit 355 and an information determination unit 309 as the basic configuration.

The control unit 355 causes an output device to output first information including a plurality of types of information. The control unit 355 causes the output device or another output device to output second information determined by the information determination unit 309.

The information determination unit 309 identifies a type to be presented to a person M and determines the second information of the identified type on the basis of the first information output by the output device and a response of the person M to the first information.

Thereby, the output control device 30 can cause the output device to output information according to the person M of a presentation target.

FIG. 10 is a schematic block diagram showing a configuration of a computer according to at least one embodiment.

A computer 900 includes a central processing unit (CPU) 901, a main storage device 902, an auxiliary storage device 903, and an interface 904.

The above-described output control device 30 is mounted in the computer 900. The operations of the above-described processing units are stored in the auxiliary storage device 903 in the form of a program. The CPU 901 reads the program from the auxiliary storage device 903, loads the program to the main storage device 902, and executes the above-described process according to the program. Also, the CPU 901 secures a storage area corresponding to each of the above-described storage units in the main storage device 902 in accordance with the program.

Also, in at least one embodiment, the auxiliary storage device 903 is an example of a non-transitory tangible medium. Other examples of the non-transitory tangible medium include a magnetic disk, a magneto-optical disk, a compact disc read only memory (CD-ROM), a digital versatile disc read only memory (DVD-ROM), a semiconductor memory, and the like connected via the interface 904. Also, if this program is distributed to the computer 900 via a communication line, the computer 900 receiving the distributed program may load the program to the main storage device 902 and execute the above-described process.

Also, the above-described program may be a program for implementing some of the above-described functions.

Further, the above-described program may be a program capable of implementing the above-described functions in combination with a program already recorded in the auxiliary storage device 903, i.e., a so-called differential file (differential program).

This application claims priority based on Japanese Patent Application No. 2016-058346, filed Mar. 23, 2016, the disclosure of which is incorporated herein.

### INDUSTRIAL APPLICABILITY

It is possible to cause an output device to output information according to a person of a presentation target.

### REFERENCE SIGNS LIST

1 Information output system

10 Imaging device

20 Digital signage device

30 Output control device

301 Image reception unit

302 Target identification unit

303 Candidate image storage unit

304 Candidate identification unit

305 First output control unit

306 Line-of-sight estimation unit

307 Available language estimation unit

308 Advertisement information storage unit

309 Information determination unit

310 Second output control unit

1. An output control device, comprising:
a control unit configured to cause an output device to output first information including a plurality of types of information; and
an information determination unit configured to identify a type to be presented to a person and determine second information of the identified type on the basis of the first information output by the output device and a response of the person to the first information,
wherein the control unit is configured to cause the output device or another output device to output the second information determined by the information determination unit.

2. The output control device according to claim 1, further comprising:
an available language estimation unit configured to estimate an available language of the person on the basis of the first information output by the output device and the response of the person,
wherein the control unit is configured to cause the output device to output the first information including information in a plurality of languages, and
wherein the information determination unit is configured to determine the second information in the available language estimated by the available language estimation unit as information to be presented to the person.

3. The output control device according to claim 1, further comprising:
a line-of-sight estimation unit configured to estimate a line of sight of the person,
wherein the control unit is configured to cause the output device to display the first information including a plurality of types of images, and
wherein the information determination unit is configured to determine the second information of the identified type to be presented to the person on the basis of a type of image to be displayed on a part of an intersection between the line of sight estimated by the line-of-sight estimation unit and the output device among the plurality of types of images.

4. The output control device according to claim 2,
wherein the control unit is configured to cause the output device to output the first information including speech information in the plurality of languages, and
wherein the available language estimation unit is configured to estimate the available language of the person on the basis of an output timing of the speech information in each of the plurality of languages and a timing of the response of the person.

5. The output control device according to claim 2, further comprising:
a candidate identification unit configured to identify a plurality of available language candidates on the basis of information of a face of the person,
wherein the control unit is configured to cause the output device to output the first information including information in the plurality of available language candidates identified by the candidate identification unit.

6. The output control device according to claim 2, wherein the control unit is configured to cause the output device to output the first information including information of the same details in a plurality of languages.

7. An output control method, comprising:
causing an output device to output first information including a plurality of types of information;
identifying a type to be presented to a person and determining second information of the identified type on the basis of the first information output by the output device and a response of the person to the first information; and
causing the output device or another output device to output the determined second information.

8. A non-transitory computer-readable recording medium storing a program that causes a computer to execute processes, the processes comprising:
causing an output device to output first information including a plurality of types of information;
identifying a type to be presented to a person and determining second information of the identified type on the basis of the first information output by the output device and a response of the person to the first information; and
causing the output device or another output device to output the determined second information.
